(19) United States
(12) Patent Application Publication
(10) Pub. No.: US 2022/0195987 A1
(43) Pub. Date: Jun. 23, 2022

(54) WIND TURBINE

(71) Applicants: Yurii Valentinovitch KRIULIN, Irkutsk (RU); Valentin Vasilevitch BOIKO, Mescherino, Stupenskii (RU); Sergey Viktorovitc CHUFISTOV, Moscow (RU)

(72) Inventors: Yurii Valentinovitch KRIULIN, Irkutsk (RU); Valentin Vasilevitch BOIKO, Mescherino, Stupenskii (RU); Sergey Viktorovitc CHUFISTOV, Moscow (RU)

(21) Appl. No.: 17/601,447

(22) PCT Filed: Apr. 20, 2020
(86) PCT No.: PCT/RU2020/000122

§ 371 Date: Oct. 5, 2021

(30) Foreign Application Priority Data
Apr. 5, 2019 (RU) 2019110206

(51) Int. Cl. F03D 9/25; F03D 3/04; F03D 9/00; H02K 7/18; H02S 10/12

(52) U.S. Cl. CPC F03D 9/25; F03D 3/04; F03D 9/007; F05B 2220/706; H02S 10/12; F05B 2220/708; H02K 7/183

(57) ABSTRACT

The utility model relates to alternative energy. The present wind turbine includes a symmetrical housing, which tapers from a lower part to an upper part and has a hemispherical fairing mounted thereabove, and lateral ribs which are vertically fastened on the housing and on which is fastened an annular fairing with a convex outer surface, a multi-bladed wind impeller being rigidly fastened inside of said annular fairing on a vertical electric generator shaft, wherein the hemispherical fairing has an aerodynamic annular baffle fastened in the lower part thereof, and the hemispherical fairing is configured to have a diameter greater than the diameter of the annular fairing with a convex outer surface. The utility model is aimed at increasing the speed of an air stream passing through the plane of rotation of a wind impeller while simultaneously preventing meteorological precipitation and foreign objects from entering the plane of rotation of the wind impeller.

The proposed utility model relates to alternative energy, using air to rotate a wind impeller installed in a wind turbine to generate electricity under various weather conditions, even the most adverse (freezing rain, hail, hurricane).

A wind turbine is known that is selected as an analogue of the claimed utility model according to patent RU 2644000 C1, published on Feb. 6, 2018, in which the wind turbine body is made in the form of a ball. In order to increase the speed of the air stream from the lower part of the wind turbine to the area of reduced pressure on the upper part of the fairing, the guide ribs are made with an inclination that facilitates the movement of air and its rotation from the horizontal direction to the vertical direction to pass through the plane of rotation of the wind impeller. Adverse weather conditions, wind, sleet, foreign objects lifted into the air by a strong wind, etc. reduce the performance of the wind turbine due to the possibility of meteorological precipitation entering the plane of rotation of the wind impeller.

The closest analogue (prototype) of the claimed utility model in terms of the combination of features and the achieved result is a wind turbine according to patent EA 023719 B1, published on Jul. 29, 2016. The body of the known wind turbine is made tapering from the lower part to the upper part. The fairing has a hemispherical shape, in the upper part of which a vacuum is created from the action of the wind flow similar to the convex side of an aircraft wing. Air masses move from the lower part of the body, where the pressure is higher than the kinetic energy of the wind, through the plane of the wind impeller fastened to an electric generator, thus rotating it, to the upper part toward the fairing where the pressure is lower. Adverse weather conditions, multidirectional wind, sleet, foreign objects lifted into the air by strong winds, etc. complicate the operation of the wind turbine. To ensure normal operating conditions and eliminate the entry of meteorological precipitation into the plane of rotation of the wind impeller, the fairing is moved along telescopic struts downward close to the annular fairing, thereby blocking the access of precipitation and foreign objects. The disadvantage of the known technical solution is the low pressure differential between the fairing and the body, which does not ensure movement of air at high speed through the plane of the wind impeller, thus limiting the performance of the wind turbine.

The technical problem to be solved by the claimed utility model is to increase the efficiency of a wind turbine.

The technical result consists in increasing the speed of the air flow passing through the plane of rotation of the wind impeller while protecting against the entry of meteorological precipitation and foreign objects into the plane of rotation of the wind impeller.

To increase the speed of the air flow passing through the plane of rotation of the wind impeller and increase the performance of the wind impeller while protecting against the entry of meteorological precipitation and foreign objects into the plane of rotation of the wind impeller, an additional vacuum is created in the upper part of the claimed wind turbine. To do this, a ring-shaped aerodynamic baffle is fastened to the lower part of the hemispherical fairing, which creates an additional vacuum when air flows around it and closes the side space between the upper hemispherical fairing and the annular fairing with a convex outer surface of the wind turbine. The aerodynamic baffle of the hemispherical fairing creates an additional vacuum area above the plane of rotation of the wind impeller, thus making it possible to increase the speed of the air passing through the plane of rotation of the wind impeller from the high pressure zone and completely closing the side space between the hemispherical fairing and the annular fairing to prevent the entry of meteorological precipitation and foreign objects into the plane of rotation of the wind impeller, while the fairing does not need to move downward.

The utility model is described in more detail by example and is accompanied by corresponding drawings, in which:

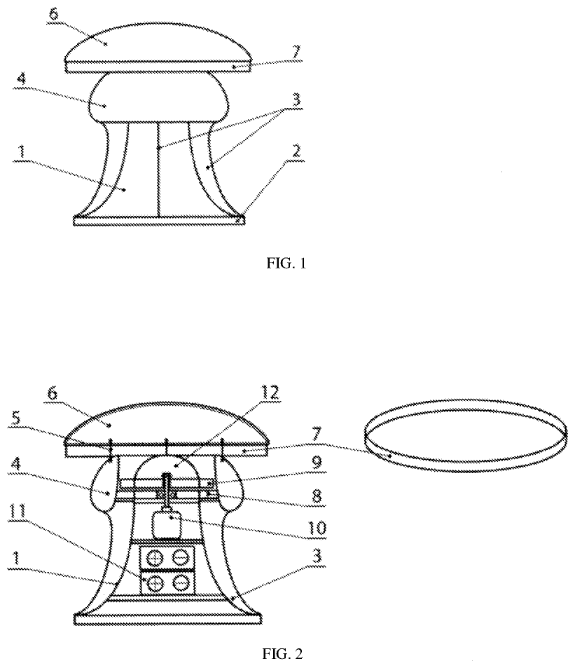

FIG. 1 is a general side view of a wind turbine;

FIG. 2 is a cross-sectional side view of a wind turbine and the basic design of an annular aerodynamic baffle;

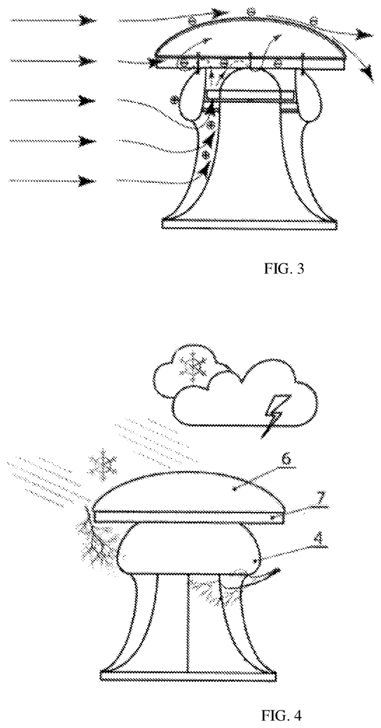

FIG. 3 is a schematic diagram of the movement of air masses relative to a working wind turbine;

FIG. 4 is a schematic diagram of the operation of a wind turbine under adverse weather conditions.

The wind turbine (FIG. 1) consists of a body 1, tapering from the lower part to the upper part, installed on a shock-absorbing base 2. On the body 1 are vertically fastened lateral surface ribs 3, which together with the tapering body 1 act as an open flow passage for the oncoming air flow. The lateral ribs 3 in the upper part of the body 1 abut an annular fairing 4 with a convex outer surface, on the struts 5 of which a hemispherical fairing 6 is fastened, in the upper convex part of which a vacuum is created when exposed to the wind and which has an aerodynamic annular baffle 7 in its lower part. The diameter of the hemispherical fairing 6 with the aerodynamic baffle 7 exceeds the diameter of the annular fairing 4 with a convex outer surface. On the inner side of the annular fairing 4 with a convex outer surface, on the base 1 is rigidly fastened a stationary guide device 8, above which a multi-blade wind impeller 9 is fastened in the immediate vicinity, rigidly installed on the vertical shaft of the electric generator 10, which is electrically connected to the storage battery 11. On the wind impeller 9 is fastened a spherical fairing 12 that rotates together with the wind impeller 9.

The wind turbine works as follows. In the presence of wind, regardless of its direction, air masses having excess pressure from the kinetic energy of the wind move to the region of reduced pressure on the hemispherical fairing 6 and on the annular aerodynamic baffle 7 along the tapering symmetrical body 1 down the vertical ribs 3 to the fixed blades 8 of the guide device. In the guide blades 8 the air flow is deflected at an optimal angle, which is in the range from 15° to 20°, and at this angle it passes through the blades of the multi-blade wind impeller 9, creating aerodynamic forces directed toward the rotation of the wind impeller 9.

The wind impeller 9 is rigidly fastened to the shaft of the electric generator 10, which as it rotates generates electricity, accumulating it in the storage battery 11 for further transmission to consumers. Having passed through the plane of rotation of the wind impeller 9, the air masses continue to move into the area of reduced pressure formed from the wind on the upper part of the hemispherical fairing 6 and on the outer side surface of the annular aerodynamic baffle 7 (FIG. 3).

The outer surfaces of the hemispherical fairing 6, the annular fairing 4 with a convex outer surface, and the body 1 are covered with sun-absorbing elements that make it possible to generate electricity from solar radiation regardless of the wind speed or in its absence.

The hemispherical fairing 6 with an aerodynamic baffle 7, an annular fairing 4 with a convex outer surface, lateral ribs, and a tapering body assure an increase in the speed of the air flow passing through the plane of the wind impeller of a wind turbine even in emergency situations: in the event of a hurricane, storm winds, i.e. when the wind speed exceeds 30 m/s, and given the presence of foreign objects in the air (FIG. 4).

1. A wind turbine, including a symmetrical body tapering from the lower part to the upper part above which a hemispherical fairing is installed, and lateral ribs vertically fastened to the body to which an annular fairing with a convex outer surface is fastened, inside which a multi-blade wind impeller is rigidly fastened to the vertical shaft of the electric generator, characterized in that the hemispherical fairing has an annular aerodynamic baffle in its lower part while the hemispherical fairing with an annular aerodynamic baffle is made with a diameter greater than the diameter of the annular fairing with a convex outer surface.

2. The turbine of claim 1, characterized in that on the outer surfaces of the hemispherical fairing, lateral ribs, annular fairing with a convex outer surface, and body are fastened elements for converting solar radiation into electricity.
